(19) United States
(12) Patent Application Publication
(10) Pub. No.: US 2017/0154294 A1
(43) Pub. Date: Jun. 1, 2017

(54) PERFORMANCE EVALUATION DEVICE, CONTROL METHOD FOR PERFORMANCE EVALUATION DEVICE, AND CONTROL PROGRAM FOR PERFORMANCE EVALUATION DEVICE

(71) Applicant: FRONTEO, Inc., Tokyo (JP)

(72) Inventors: Masahiro MORIMOTO, Tokyo (JP); Naritomo IKEUE, Tokyo (JP); Hideki TAKEDA, Tokyo (JP)

(21) Appl. No.: 15/321,711

(22) PCT Filed: Jul. 30, 2014
(86) PCT No.: PCT/JP2014/070117

§ 371 Date: Dec. 22, 2016

(51) Int. Cl. G06Q 10/06

(52) U.S. Cl. CPC G06Q 10/06398

(57) ABSTRACT

In order to quickly and efficiently evaluate the results of a worker, this result evaluation device is provided with: a memory unit that stores judged data used as basic information allowing a manager to evaluate the quality of a result; a relationship evaluation unit that, when unjudged data, which is not used as basic information for evaluating the quality of a result, is newly acquired from a worker, evaluates the relationship between the unjudged data and the result being good on the basis of the judged data stored in the memory unit; and a quality determination unit that determines the quality of the result in accordance with the relationship evaluated by the relationship evaluation unit.

### TECHNICAL FIELD

The present invent ion relates to a performance evaluation device that evaluates the performance of a worker based on data, and so forth.

### BACKGROUND ART

To enhance the performance of corporate activities, evaluating the performance of each worker has been an important issue. Meanwhile, with the progress of the times, corporate activities have become complicated and sophisticated, so that the contents of business conducted by each worker in a company have become complicated, sophisticated, and diversified. Under such circumstances, there is a demand for evaluating the performance of each worker in a company quickly and appropriately. To satisfy such a demand, performance evaluation devices have been proposed.

Patent Literature 1 proposes a liaison performance evaluation device including a database for a liaison support system to store quantitative performance information about each liaison, and a liaison support hardware for converting a qualitative performance evaluation to be performed on the liaison activity of the liaison by a client and information about the quantitative performance into values, and adding up the values, thereby obtaining an evaluation value for the liaison. The client evaluates the performance of the liaison activity of the liaison in the form in which the result of the qualitative performance evaluation for the liaison by the client is reflected.

As another example of the performance evaluation devices, Patent Literature 2 proposes a business performance evaluation system including: business performance request means for dividing the content of a job into a plurality of task units and inputting, for each task, the performance of tasks in each evaluation object; business performance storage means for storing the performance of business; evaluation point request means for giving priority to each task unit, and setting evaluation points for each task unit; and evaluation point storage means for storing the evaluation points. An evaluation value for the performance of each task is calculated by making an evaluation of an evaluation object, such as an employee, to match the policy of the company so that the degree of contribution of the evaluation object to the company and the adaptability to a change in the policy can be clearly recognized.

### CITATION LIST

### Patent Literature

Patent Literature 1: Japanese Patent Laid-Open No. 2007-265177

Patent Literature 2: Japanese Patent Laid-Open No. 2006-172329

### SUMMARY OF INVENTION

### Technical Problem

As described above, a large number of performance evaluation devices for evaluating the performance of each worker have been proposed. However, in the conventional performance evaluation devices, it is necessary to create a performance evaluation criteria that match a change in business policy, separately from the evaluation of the performance of each worker, and to input the created performance evaluation criteria to the performance evaluation device, before executing the evaluation of the performance of each worker. Thus, it is difficult for the conventional performance evaluation devices to evaluate the performance of each worker efficiently and quickly.

The present invention has been made in view of the above-mentioned problems, and an object of the present invention is to provide a performance evaluation device and so forth capable of evaluating the performance of a worker efficiently and rapidly.

### Solution to Problem

To solve the above-mentioned problems, a performance evaluation device according to one aspect of the present invention is a performance evaluation device that evaluates a performance of a worker based on data, the performance evaluation device including: a storage unit configured to store judged data as basic information for evaluating a quality of the performance by a manager; a relationship evaluation unit configured to evaluate, when unjudged data is newly acquired from the worker, a relationship between the unjudged data and excellence of the performance based on the judged data stored in the storage unit, the unjudged data being not used as the basic information for evaluating the quality of the performance; and a quality determination unit configured to determine the quality of the performance according to the relationship evaluated by the relationship evaluation unit.

The performance evaluation device acceding to one aspect of the present invention may further include a score calculation unit configured to calculate a score representing a strength of a relationship between predetermined data and the excellence of the performance. The relationship evaluation unit may evaluate whether there is a relationship between the unjudged data and the excellence of the performance by using the score calculated by the score calculation unit as an index indicating the relationship between the unjudged data and the excellence of the performance. The quality determination unit may determine that the performance is excellent when the relationship evaluation unit evaluates that there is a relationship between the unjudged data and the excellence of the performance.

The performance evaluation device according to one aspect of the present invention may further include an element evaluation unit configured to evaluate each of data elements included in the judged data based on a predetermined criterion. The score calculation unit may calculate the score by using a result of the evaluation by the element evaluation unit.

The performance evaluation device according one aspect of the present invention may further include a threshold specifying unit configured to specify a score which can exceed a target value set for a precision ratio, as a predetermined threshold, among scores calculated by the score calculation unit as an index indicating the relationship between the judged data and the excellence of the performance by using a result of the evaluation by the element evaluation unit.

The performance evaluation device according one aspect of the present invention may further include a condition determination unit configured to determine a rank of a correlation between a moving average of scores calculated for a plurality of pieces of judged data acquired in times series, and a moving average of scores calculated for a plurality of pieces of unjudged data acquired in times series. The relationship evaluation unit may evaluate the relationship between the unjudged data and the excellence of the performance, based on a result of the determination by the condition determination unit.

The performance evaluation device according one aspect of the present invention may further include a judged data acquisition unit configured to acquire the judged data by acquiring a result of determination by the manager as to whether predetermined data has a relationship with the excellence of the performance via a predetermined input unit from the manager.

The performance evaluation device according one aspect of the present invention may further include a relation imparting unit configured to impart relationship information indicating that the unjudged data has a relationship with the excellence of the performance, based on a result of evaluation by the relationship evaluation unit.

The performance evaluation device according to one aspect of the present invention may further include a data acquisition unit configured to acquire at least one of a report, an e-mail, and a presentation material as the data.

To solve the above-mentioned problems, a control method for a performance evaluation device according to one aspect of the present invention is a control method for a performance evaluation device that evaluates a performance of a worker based on data, the control method including: a relationship evaluation step of evaluating, when unjudged data is newly acquired from the worker, a relationship between the unjudged data and excellence of the performance based on judged data used as basic information for evaluating a quality of the performance by a manager, the unjudged data being not used as the basic information for evaluating the quality of the performance; and a quality determination step of determining the quality of the performance according to the relationship evaluated in the relationship evaluation step.

To solve the above-mentioned problems, a control program for a performance evaluation device according to one aspect of the present invention is a control program for a performance evaluation device that evaluates a performance of a worker based on data, the performance evaluation device including a storage unit configured to store judged data used as basic information for evaluating a quality of the performance by a manager, the control program causing the performance evaluation device to execute: a relationship evaluation function of evaluating, when unjudged data is newly acquired from the worker, a relationship between the unjudged data and excellence of the performance based on the judged data stored in the storage unit, the unjudged data being not used as the basic information for evaluating the quality of the performance; and a quality determination function of determining the quality of the performance according to the relationship evaluated by the relationship evaluation function.

### Advantageous Effects of Invention

A performance evaluation device according to an embodiment of the present invention, a control method for the performance evaluation device, and a control program for the performance evaluation device are capable of evaluating a relationship between unjudged data and a predetermined case based on judged data as to which a manager has determined whether the data has a relationship with the predetermined case reporting the unjudged data to the manager according to the relationship, and assisting the evaluation by the manager, thereby making it possible to evaluate the performance of the worker efficiently and quickly.

### BRIEF DESCRIPTION OF DRAWINGS

FIG. 1 is a block diagram showing a configuration of the principal part of a performance evaluation device according to an embodiment of the present invention.

FIG. 2 is a diagram showing an example of a daily report of a sales person that is acquired as external data in the embodiment of the present invention.

FIG. 3 is a flowchart showing an example of processes executed in the embodiment of the present invention.

FIG. 4 is a graph showing, in times series, values of score S calculated based on the daily report of the sales person in the embodiment of the present invention.

### DESCRIPTION OF EMBODIMENTS

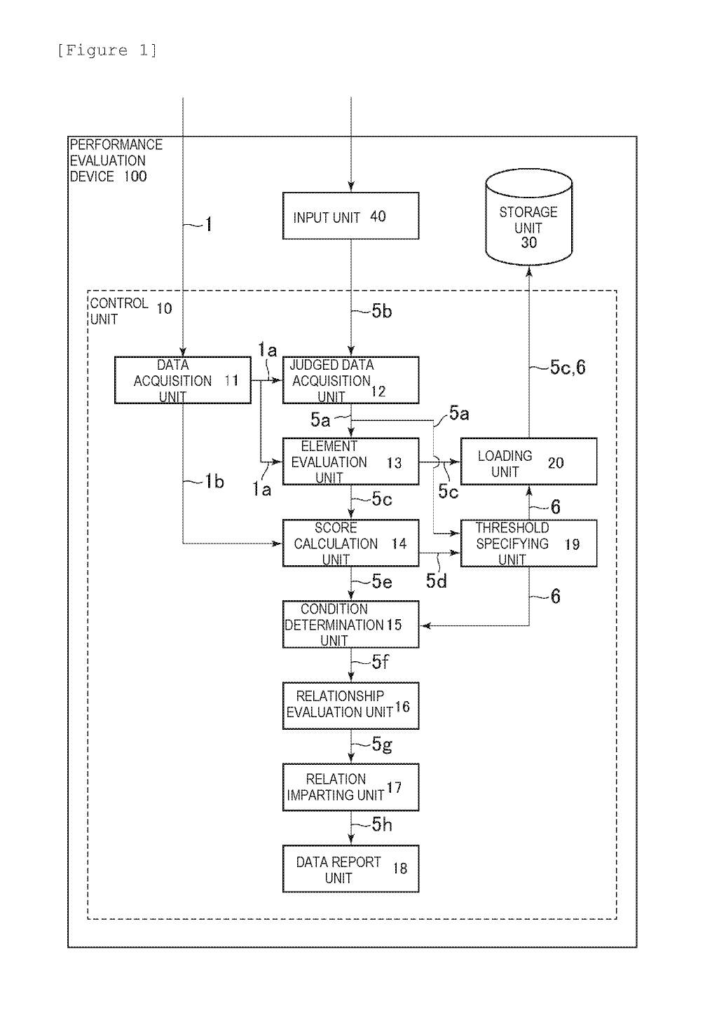

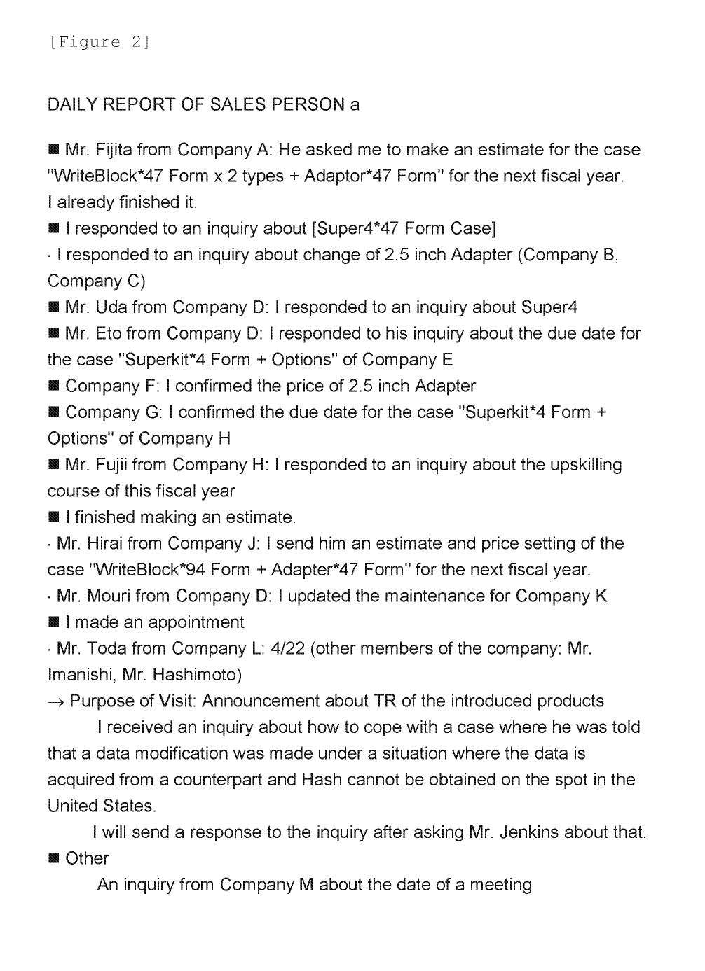

An embodiment of the present intention will be described with reference to FIGS. 1 to 5.

### [Outline of Performance Evaluation Device 100]

A performance evaluation device 100 is a device that evaluates the performance of a worker based on a plurality of pieces of data acquired from the worker. Any device may be used as the performance evaluation device 100, as long as the device can execute the processes described below. For example, the performance evaluation device can be implemented using a personal computer, a smartphone, and other electronic devices.

In general, everyday, each sales person (worker) submits a daily sales report to his/her boss (manager), reporting on how much of the sales target he has achieved in the present term, and the approach taken t achieve the sales. The performance evaluation device 100 predicts, by predictive coding, a projection of sales (performance) based on the daily sales report.

Specifically, the performance evaluation device 100 analyzes document data of “daily sales report”, evaluates the presence or absence of a relationship (correlation) between the “document data” and “excellence (or inferiority) of the performance of the sales person.” (predetermined case), and makes a judgment that, for example, “it seems that this sales person can achieve a satisfactory level of performance, or “it seems that this sales person cannot achieve the sales target at this rate, so he/she needs a support.”

Accordingly, the performance evaluation device 100 can assist the evaluation by the manager, which makes it possible to efficiently evaluate the performance of each worker.

FIG. 1 is a block diagram showing the configuration of the principal part of the performance evaluation device 100. As shown in FIG. 1, the performance evaluation device 100 acquires a daily report of a worker (for example, a sales person) as unjudged data which is not used as basic information for evaluating the quality of the performance. When the unjudged data, which is not used as basic information for evaluating the quality of the performance, is newly acquired, the performance evaluation device 100 evaluates the relationship between the unjudged data and the excellence (or inferiority) of the performance based on judged data which is used as basic information for a manager (for example, a manager having good experience in sales) to evaluate the quality of the performance.

Specifically, the performance evaluation device 100 extracts data elements 2 from data 1b, and calculates a score 5e of the data 1b from the data elements 2 that are each evaluated using the judged data. When the calculated score 5e satisfies a predetermined condition (for example, the score 5e exceeds a predetermined threshold), the performance evaluation device 100 reports the data 1b to the managers (including, for example, the manager in the sales department, other than the immediate boss of the sales person).

In other words, the performance evaluation device 100 can determine whether to report new unjudged data to the managers, based on the result of the judgment by the manager having good experience in sales as to whether the data has a relationship with “the excellence inferiority) of the performance of the sales person” (predetermined case). For example, the performance evaluation device 100 learns the relationship between the excellence/inferiority of the performance in the sales activity experienced by the manager having good experience in sales and the data indicating the excellence/inferiority of the performance in the sale activity of the predetermined case. Further, when the sales person has encountered a similar situation and similar data is obtained, the performance evaluation device 100 can report the similar data to the manager to cause the manager to warn the sales person who has encountered the similar situation.

Accordingly, the performance evaluation device 100 provides an advantageous effect that only the data truly required by the manager (for example, data indicating a situation which is highly likely to cause poor sales activities) can be reported to the manager.

### [Configuration of Data Analysis Device 100]

As shown in FIG. 1, the performance evaluation device 100 includes a control unit 10 (a data acquisition unit 11, a judged data acquisition unit 12, an element evaluation unit 13, a score calculation unit 14, a condition determination unit 15, a relationship evaluation unit 16, a relation imparting unit 17, a data report unit 18, a threshold specifying unit 19, a loading unit 20), an input unit 40, and a storage unit 30.

The control unit 10 generally controls various functions included in the performance evaluation device 100. The control unit 10 includes the data acquisition unit 11, the judged data acquisition unit 12, the element evaluation unit 13, the score calculation unit 14, the condition determination unit 15, the relationship evaluation unit 16, the relation imparting unit 17, the data report unit 18, the threshold specifying unit 19, and the loading unit 20.

The data acquisition unit 11 acquires data 1 from the outside of the performance evaluation device 100. The data acquisition unit 11 acquires data, such as a daily report of a sales person, as the data 1 from the outside of the performance evaluation device 100.

The data acquisition unit 11 outputs, to the judged data acquisition unit 12 and the element evaluation unit 13, data 1a, which is judged by the manager as to whether the data has a relationship with the predetermined case, in the acquired data 1, and outputs the other data 1b (unjudged data) to the score calculation unit 14.

The judged data acquisition unit 12 acquires the judged data (a pair of the data 1a and a review result 5a) by acquiring, from the manager, the result (review result 5a) of the judgment by the manager as to whether the data 1a has a relationship with “the excellence (or inferiority) of the performance of the sales person”, via the input unit 40. Specifically, the judged data acquisition unit 12 acquires the review result 5a corresponding to the data 1a received from the data acquisition unit 11 based on the input information 5b acquired from the input unit 40. Further, the judged data acquisition unit 12 outputs the review result 5a to the element evaluation unit 13 and the threshold specifying unit 19.

Note that the manager who provides the performance evaluation device 100 with the review result 5a and the manager who receives the review result from the performance evaluation device 100 (i.e., the data 1b is reported from the performance evaluation device 100) may be the same or different managers. In the latter case, for example, the performance evaluation device 100 can learn experience/judgment criteria for the manager having good experience in sales and can report the data 1b to the manager who does not have much experience in sales, based on the learned result. In other words, the performance evaluation device 100 can make use of the experience of the manager having good experience in sales for the manager who does not have much experience in sales.

The element evaluation unit 13 evaluates each data element included in the judged data based on predetermined criteria. Specifically, when the data 1a indicates a document (for example, a daily report), the element evaluation unit 13 uses, as one of the above-mentioned predetermined criteria, the amount of transmitted information, which represents the dependence between a keyword (for example, a data element such as a morpheme) included in the document and a result (review result 5a) of the judgment by the manager on the data 1a (document) including the keyword, and calculates the weight of the keyword, thereby making it possible to evaluate the keyword.

Alternatively, when the data 1a indicates a sound, the element evaluation unit 13 recognizes the sound to thereby convert the sound into characters (document data). Further, the element evaluation unit 13 uses, as one of the above-mentioned predetermined criteria, the amount of transmitted information representing the dependence between a keyword (data element) included in the document data and the result (review result 5a) of the judgment by the manager on the data 1a (sound) including the keyword, and calculates the weight of the keyword, thereby making it possible to evaluate the keyword. Note that the element evaluation unit 13 may recognize the sound using an sound recognition algorithm (such as Hidden Markov Model, Kalman filter, or a neural network).

Alternatively, when the data 1a indicates an image, the element evaluation unit 13 uses any image recognition technique (for example, a technique such as pattern matching, Bayesian inference, or Markov chain Monte Carlo methods) to specify objects (such as a person, a background, a vehicle, and a building) included in the image, as data elements. Further, the element evaluation unit 13 uses, as one of the above-mentioned predetermined criteria, the amount of transmitted information representing the dependence between an object (data element) included in the image and the result (review result 5a) of the judgment by the manager on the data 1a (image) including the object, and calculates the weight of the object, thereby making it possible to evaluate the object. The element evaluation unit 13 outputs, to the score calculation unit 14 and the loading unit 20, element information 5c which is a pair of the data element and the weight of the data element.

The score calculation unit 14 uses the result (element information 5c) of the evaluation made by the element evaluation unit 13, and calculates a score 5d representing the strength of the relationship between the data 1a and the predetermined case (the excellence of the performance of the sales person). The score calculation unit 14 outputs the calculated score 5d to the threshold specifying unit 19. Upon receiving the data 1b (unjudged data) from the data acquisition unit 11, the score calculation unit 14 calculates the score 5e for the data 1b, and outputs the calculated score 5e to the condition determination unit 15.

The score calculation unit 14 can calculate the score (the score 5d or the score 5e) for the data 1 by adding yip the weights of the data elements included in the data 1 (the data 1a or the data 1b).

Specifically, the score calculation unit 14 generates an element vector indicating whether a predetermined data element is included in the data 1. The element vector is a vector indicating whether the predetermined data element associated with each element is included in the data 1 when the element of the element vector takes a value of “0” or “1”. The score calculation unit 14 calculates, as in the following formula, a score S of the data 1 by calculating the inner product of the element vector (a column vector) and a weight vector (a column vector using the weight of each data element as an element).

S=w^{T}·s [Formula 1]

where s represents the element vector; W represents the weight vector; and I represents the transposition of matrix/vector (replacement of row and columns).

Alternatively, the score calculation unit 14 may calculate the score S in accordance with the following formula.

$$S = \frac{{\sum }_{j = 1}^{N} {m}_{j} {w}_{j}^{2}}{{\sum }_{i = 1}^{N} {w}_{i}^{2}} \qquad [ Formula 2 ]$$

where m represents the appearance frequency of the j-th data element, and wᵢ represents the weight of the i-th data element.

The score calculation unit 14 may calculate the score 5d and/or the score 5e based on the result (the weight of a first data element) of the evaluation of the first data element included in the data 1a and/or the data 1b, and on the result (the weight of a second data element) of the evaluation of the second data element included in the data 1a and/or the data 1b. Specifically, when the first data element appears in the data, the score calculation unit 14 can calculate the score of the data in consideration of the frequency of appearance of the second data element in the data (i.e., the correlation between the first data element and the second data element, which is also referred to as co-occurrence). Thus, the data analysis device 100 can calculate the score in consideration of the correlation relationship between data elements, thereby making it possible to extract data having a relationship with the predetermined case with high accuracy.

The condition determination unit 15 determines whether the data 1b satisfies a predetermined condition for reporting the data 1b to the manager, based on the score 5e calculated by the score calculation unit 14. For example, the condition determination unit 15 compares the score Se with a threshold of the precision ratio (predetermined threshold) 6, and determines whether the score Se exceeds the threshold 6 of the precision ratio, as one of the predetermined condition.

Alternatively, the condition determination unit 15 may determine, as one of the above-mentioned predetermined condition, whether the correlation between the moving average of the scores 5d, which are calculated for the plurality of pieces of data 1a acquired in time series, and the moving average of the scores 5e, which are calculated for the plurality of pieces of data 1b acquired in time series, is increased. For example, when the plurality of pieces of data 1a indicate that the review result 5a indicating the situation in which the sales activity is at a dead end is obtained from the manager having good experience in sales, the condition determination unit 15 extracts, as a predetermined pattern, the moving average of the scores 5d calculated for the plurality of pieces of data 1a.

Further, the condition determination unit 15 calculates the correlation between the predetermined pattern and the moving average of the scores 5e. In other words, the condition determination unit 15 calculates the degree of coincidence (correlation) between the predetermined pattern and the moving average while shifting the elapsed time and/or the score. When the correlation is high, the condition determination unit 15 determines that, in the future, the current score Se will take a similar value (that is, the situation in which the sales activity is at a dead end is highly likely to occur) so that the value is linked to the predetermined pattern.

When the unjudged data (data 1b,) which is not judged as to whether the data has a relationship with the predetermined case (the excellence of the performance of the sales person), is newly acquired, the relationship evaluation unit 16 evaluates the relationship between the unjudged data and the predetermined case based on the judged data (a pair of the data 1a and the review result 5a) which is judged by the manager as to whether the data has a relationship with the predetermined case. For example, when the score Se calculated by the score calculation unit 14 exceeds the threshold 6 as the index indicating the relationship between the unjudged data (data 1b) and the predetermined case (i.e., when the condition determination unit 15 determines that the score exceeds the threshold), the relationship evaluation unit 16 evaluates that there is a relationship between the unjudged data and the predetermined case. The relationship evaluation unit 16 outputs an evaluation result (evaluation result 5g) to the relation imparting unit 17.

The relation imparting unit 17 imparts relationship information 5h indicating that the unjudged data (data 1b) has a relationship with the predetermined case (the excellence of the performance of the sales person) based on the result (evaluation result 5g) of the evaluation by the relationship evaluation unit 16, and outputs the relationship information 5h to the data report unit 18.

The data report unit 18 reports the unjudged data (data 1b) to the manager according to the relationship evaluated by the relationship evaluation unit 16. Specifically, the data report unit 18 reports, to the manager, the data 1b to which the relationship information 5h indicating that the performance of the sales person is excellent (or poor) is imparted by the relation imparting unit 17.

The threshold specifying unit 19 specifies, as the threshold 6 of the precision ratio, a minimum score that can exceed a target value (target precision ratio) set for a precision ratio indicating the ratio of the data 1a, which is judged to have a relationship with the predetermined case, to a data set including a predetermined number of pieces of data. Specifically, when the scores 5d are input from the score calculation unit 14, the threshold specifying unit 19 sorts the scores 5d in a descending order. Next, the threshold specifying unit 19 scans the review result 5a which is imparted to the data 1a in the order from the data 1a having the maximum score 5d (the score is ranked first), and sequentially calculates the ratio (precision ratio) of the number of pieces of data to which the review result 5a indicating that “there is a relationship with the predetermined case” (the performance of the sales person is excellent or poor), to the number of pieces of data for which scanning is finished at the present time.

For example, in a case where the number of pieces of data 1a to which the review result 5a is imparted is 100, when scanning for the data having scores that are ranked first to 20th is finished and the number of pieces of data to which the review result 5a indicating that “there is a relationship with the predetermined case” is imparted is 18, the threshold specifying unit 19 calculates the precision ratio as 0.9 (18/20). Alternatively, when scanning of the data having scores that are ranked first to 40th is finished and the number of pieces of data to which the review result 5a indicating that “there is a relationship with the predetermined case” is imparted is 35, the threshold specifying unit 19 calculates the precision ratio as 0.875 (35/40).

The threshold specifying unit 19 calculates all precision ratios for the data 1a, and specifies the minimum score that can exceed the target precision ratio. Specifically, the threshold specifying unit 19 scans the precision ratio calculated for the data 1a in the order from the data 1a having the minimum score 5d (the score is ranked 100th), and when the precision ratio exceeds the target precision ratio, the threshold specifying unit 19 outputs the score corresponding to the precision ratio to the condition determination unit 15 and the loading unit 20 as the minimum score (threshold 6 of the precision ratio) at which the target precision ratio can be maintained.

Upon receiving the element information 5c from the element evaluation unit 13, the loading unit 20 loads, in the storage unit 30, the data elements included in the element information 5c and the result (weight) of the evaluation of the data elements in such a manner that the data elements and the result are associated with each other. Thus, the performance evaluation device 100 analyzes the current data based on a result of analyzing previous data (a weight obtained as a result of evaluating data elements), thereby making it possible to extract the data having a relationship with the predetermined case. When the threshold 6 of the precision ratio is input from the threshold specifying unit 19, the loading unit 20 loads the threshold 6 of the precision ratio in the storage unit 30.

The input unit (predetermined input unit) 40 receives an input from the manager. FIG. 1 shows a configuration in which the performance evaluation device 100 includes the input unit 40 (for example, a configuration in which a keyboard, a mouse, or the like is connected as the input unit 40). The input unit 40 may be an external input device (such as a client terminal) which is connected to the performance evaluation device 100 in such a manner that the input device can communicate with the performance evaluation device 100.

The storage unit (predetermined storage unit) 30 is, for example, a storage device composed of any recording medium such as a hard disk, an SSD (solid state drive), a semiconductor memory, or a DVD, and stores the element information 5c, the threshold 6 of the precision ratio, and/or a control program capable of controlling the performance evaluation device 100. FIG. 1 illustrates a configuration in which the performance evaluation device 100 incorporates the storage unit 30. However, the storage unit 30 may be an external storage device that is connected to the performance evaluation device 100 in such a manner that the storage device can communicate with the performance evaluation device 100.

### [Re-Calculation of Weight]

After the data 1b which is judged by the performance evaluation device 100 to have a relationship with the predetermined case (the excellence or the poor of the performance of the sales person) is reported to the manager by the data report unit 18, the judged data acquisition unit 12 can accept a feedback for the judgment from the manager. Specifically, the manager can input the feedback as to whether the result of the judgment by the performance evaluation device 100 is reasonable. The element evaluation unit 13 can evaluate the data elements again based on the feedback.

In other words, the element evaluation unit. 13 can re-calculate the weight based on the feedback newly obtained for the judgment of the performance evaluation device 100. Thus, the performance evaluation device 100 can acquire the weight compatible with the data to be analyzed and calculate the score accurately based on the weight, thereby making it possible to extract the data having a relationship with the predetermined case with high accuracy.

### [Process to be Executed by the Performance Evaluation Device 100]

A process to be executed by the performance evaluation device 100 (a control method for the performance evaluation device 100) includes: a relationship evaluation step of evaluating, when unjudged data (data 1b), which is not used as basic information for evaluating the quality of a performance, is newly acquired from a worker (for example, a sales person), a relationship between the unjudged data and the excellence of the performance based on judged data (a pair of the data 1a and the review result 5a), which is used by a manager as basic information for evaluating the quality of the performance; and a quality decision step of deciding the quality of the performance according to the evaluated relationship.

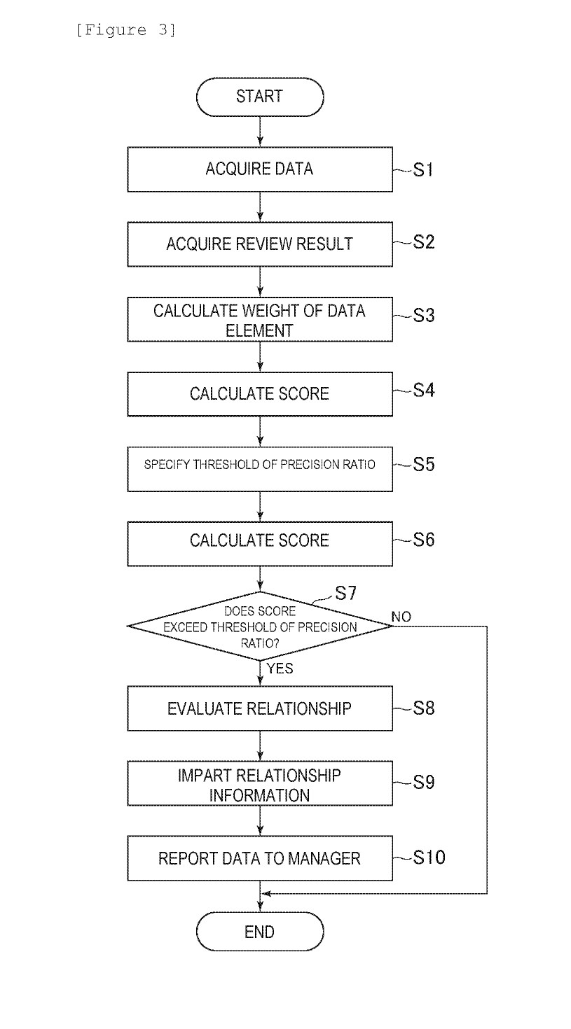

FIG. 3 is a flowchart showing an example of the process to be executed by the performance evaluation device 100. Note that in the following description, “˜step” noted in brackets represents each step included in the control method for the performance evaluation device.

The data acquisition unit 11 acquires the data 1a to be judged by the manager as to whether the data has a relationship with the predetermined case (for example, from a daily report or the like of the sales person) (step 1; “step” is hereinafter abbreviated as “S”). Next, the judged data acquisition unit 12 acquires, via the input unit 40, the result (review result 5a) of the judgment by the manager as to whether the data 1a has a relationship with the predetermined case (S2). Next, the element evaluation unit 13 evaluates each data element, which is included in data judged by the manager as to whether the data has a relationship with the predetermined case, based on the predetermined criterion (S3). The score calculation unit 14 calculates, for each data 1a, the score 5d representing the strength of the relationship between the data and the predetermined case based on the result (element information 5c) of the evaluation by the element evaluation unit 13 (S4), and the threshold specifying unit 19 specifies, as the threshold 6 of the precision ratio, as the minimum score that can exceed the target value (target precision ratio) set for the precision ratio indicating the ratio of the data 1a, which is judged to have a relationship with the predetermined case, to the data set including the predetermined number of pieces of data (S5).

Next, the score calculation unit 14 calculates, for data 1b, the score 5e indicating the strength of the relationship with the predetermined case based on the result (element information 5c) evaluated by the element evaluation unit 13 (S6). The condition determination unit 15 determines whether the score 5e, which is calculated for the data 1b that is not judged as to whether the data has a relationship with the predetermined case based on the result (element information 5c) of the evaluation by the element evaluation unit 13, exceeds the threshold 6 of the precision ratio (S7). When it is determined that the score Se exceeds the threshold 6 of the precision ratio (YES in S7), the relationship evaluation unit 16 evaluates that the data 1b has a relationship with the predetermined case (S8, a relationship evaluation step).

The relation imparting unit 17 imparts, to the data 1b evaluated by the relationship evaluation unit 16, the relationship information (review result obtained by the performance evaluation system 100) indicating that the data 1b has a relationship with the predetermined case (S9). Lastly, the data report unit 18 reports the data 1b to the manager (S10, a data report step).

Note that the control method includes the process described above with reference to FIG. 3, but may also include any process to be executed by each unit included in the control unit 10.

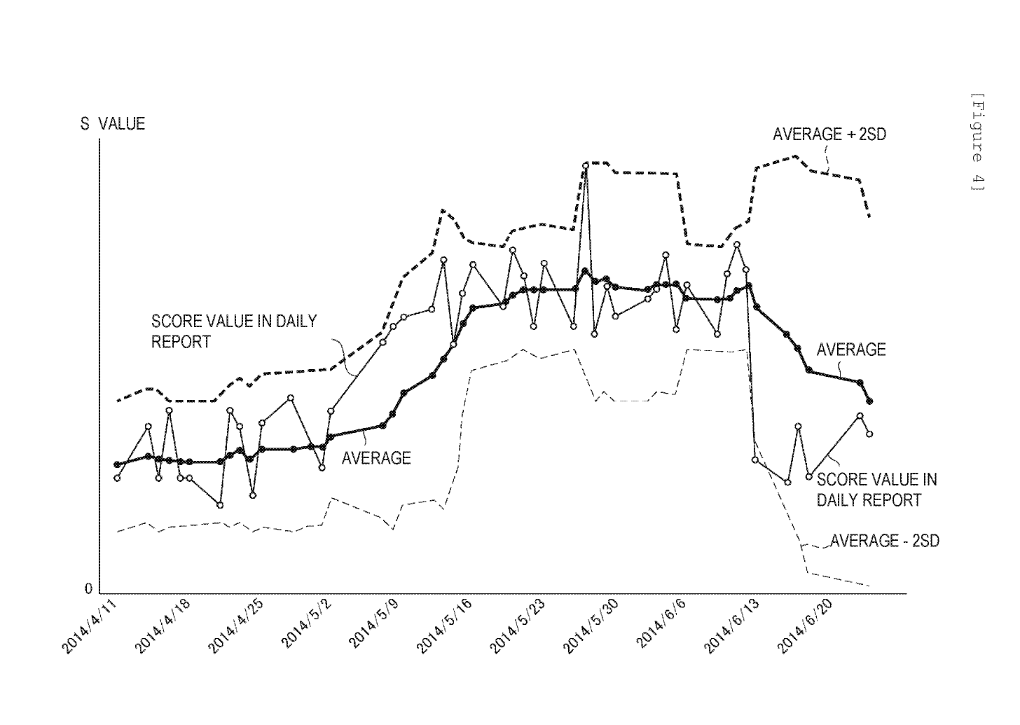

FIG. 4 is a diagram showing, in time series, the values of the score S as the index indicating the relationship between daily reports of a sales person and the excellence of his/her business performance, which is calculated based on the daily report of the sales person by the performance evaluation device according to the embodiment of the present invention. FIG. 4 illustrates the score values of the sales person, the moving average value of the score values of the sales person, (moving average value)+(two standard deviation values), and (moving average value)−(two standard deviation values). Examples according to an embodiment of the present invention will be described below with reference to FIG. 4.

### Example 1

(1) As shown in FIG. 4, the moving average of the scores which are evaluated, for each sales person, as to the presence or absence of the relationship between daily reports of the sales person and the excellence of his/her business performance is calculated; and (2) the sales person waving the moving average score that exceeds the standard deviation calculated from the scores of all sales persons is judged to be “performance excellent”, and the sales person having the moving average score that is lower than the standard deviation is judged to be “performance poor”. Thus, the standard deviation is used as a threshold for judgment to be excellent/poor.

The performance evaluation device according to the embodiment of the present invention, the control method for the performance evaluation device, and the control program for the performance evaluation device are capable of assisting the evaluation by the manager, thereby making it possible to efficiently evaluate the performance of each worker.

### Example 2

(1) As shown in FIG. 4, the moving average of the scores which are evaluated, for each sales person, as to where there is a relationship between the daily reports of each sales person and the excellence of their business performances is calculated, and (2) when the pattern of the moving average of the scores calculated up to the present time is compared with the pattern of the moving average of the scores calculated previously and when the correlation between the patterns is high, which indicates that the same pattern as the previous pattern is followed, it can be predicted that the performance of the sales person may be shifted in the same manner as the previous performance.

The performance evaluation device according to the embodiment of the present invention, the control method for the performance evaluation device, and the control program for the performance evaluation device are capable of predicting the performance of each worker, thereby making it possible to take appropriate measures, such as, an early support for the sales person whose performance may deteriorate, according to the prediction.

### [Advantageous Effects Provided by the Performance Evaluation Device 100]

As described above, when the unjudged data, which is not judged as to whether the data has a relationship with the predetermined case, is newly acquired, the performance evaluation device 100 evaluates the relationship between the unjudged data and the predetermined case based on the judged data that is judged by the manager as to whether the data has a relationship with the predetermined case, and reports the unjudged data to the manager according to the relationship.

Accordingly, the performance evaluation device 100 provides an advantageous effect that only the data truly required by the manager can be reported to the manager.

[Configuration in which a Server Device Provides a Part or all of Functions]

The configuration (stand-alone configuration) in which the performance evaluation device 100 executes the control program for the performance evaluation device capable of extracting data having a relationship with a predetermined case from among a plurality of pieces of data acquired from the outside of the performance evaluation device 100 has been described above.

It is also possible to employ a configuration (cloud configuration) in which a server device executes the whole or part of the control program, and the result of the executed process is returned to the performance evaluation device 100 (user terminal). In other words, the performance evaluation device according to the present invention can function as a server device that is connected to a user terminal in such a manner that the server device can communicate with the user terminal via a network. Thus, when the performance evaluation device 100 has the function, the server device provides the same advantageous effect as that of the performance evaluation device 100.

### [Examples of Implementation by Software]

The control block of the performance evaluation device 100 may be implemented by a logic circuit (hardware) formed in an integrated circuit (IC chip) or the like, or may be implemented by software using a CPU (Central Processing Unit). In the latter case, the performance evaluation device 100 includes, for example, a CPU that executes instructions from the control program for the performance evaluation device 100 that is software for implementing functions; one of a ROM (Read Only Memory) and a storage device (these are referred to as a “recording medium”) which store the control program and various data so that the control program and various data can be read by a computer (or the CPU); and a RAM (Random Access Memory) for expanding the control program. The computer (or the CPU) reads the control program from the recording medium and executes the read control program, thereby achieving the object of the present invention. As the recording medium, “non-transitory tangible media”, such as a tape, a disk, a card, a semiconductor memory, and a programmable logic circuit, can be used. The control program may be supplied to the computer through any transmission media (communication network, broadcast wave, etc.) capable of transferring the control program. The present invention can also be implemented in the form of a data signal buried in a carrier wave in which the control program is embodied by electronic transmission.

Specifically, the control program for the performance evaluation device according to the embodiment of the present invention is a control program for the performance evaluation device capable of extracting data having a relationship with the predetermined case from among a plurality of pieces of data acquired from the outside of the performance evaluation device, the control program causing the performance evaluation device to implement the relationship evaluation function and the data report function. The relationship evaluation function and the data report function can be implemented by the relationship evaluation unit 16 and the data report unit 18, respectively. These functions have been described in detail above.

In the performance evaluation device according to one aspect of the present invention, the element evaluation unit can evaluate a data element by using, as one of the predetermined criteria, the amount of transmitted information representing the dependence between the data element and the result of the judgment by the manager on the judged data including the data element.

Note that the control program can be implemented using a script language, such as Python, ActionScript, or javaScript®, an object-oriented programming language such as Objective-C, or Java®, or a markup language such as HTML5.

### [Supplementary Note 1]

The present invention is not limited to the embodiments described above and can be modified in various ways within the scope of the claims. Embodiments obtained by combining technical means disclosed in different embodiments as appropriate are also included in the technical scope of the present invention. Further, new technical features can be provided by combining technical means disclosed in the embodiments.

### [Supplementary Note 2]

The performance evaluation device according to one aspect of the present invention acquires digital information including document information, worker information, and access history information, designates a specific worker from the workers included in the worker information, extracts only the document information accessed by the specific worker based on the access history information about the designated specific worker, sets additional information indicating whether a document file of the extracted document information is related to a predetermined case, and outputs the document file related to the predetermined case based on the additional information.

The performance evaluation device according to one aspect of the present invention acquires digital information including document information and worker information, sets worker specifying information indicating which one of the workers included in the worker information is related, designates a worker, retrieves a document file in which the worker specifying information corresponding to the designated worker is set, sets additional information indicating whether the retrieved document file is related to a predetermined case, and outputs the document file related to the predetermined case based on the additional information.

The performance evaluation device according to one aspect of the present invention acquires digital information including document information and user information, accepts the designation of a document file included in the document information to be translated into any language, translates the document file, extracts a common document file indicating the same content as the designated document file from the document information, generates translation related information indicating that the extracted common document file is translated by incorporating therein the content of translation of the translated document file, and outputs the document file related to a predetermined case based on the translation related information.

The performance evaluation device according to one aspect of the present invention stores, in a keyword database, (1a) a classification sign “A”, (1b) a keyword included in the document to which the classification sign “A” is imparted, and (1c) keyword correspondence information indicating a correspondence relationship between the classification sign “A” and the keyword; stores, in a related terminology database, (2a) a classification sign “B”, (2b) a related terminology having a high appearance frequency in the document to which the classification sign “B” is imparted, and (2c) related terminology correspondence information indicating a correspondence relationship between the classification sign “B” and the related terminology; imparts the classification sign “A” to the document including the keyword (1b) based on the keyword correspondence information (1c); extracts the document including the related terminology (2b) from the document to which the classification sign “A” is not imparted in the imparting process; calculates a score based on the evaluation value and number of the related terminology; imparts the classification sign “B” to the document having a score that exceeds a certain value based on the score and the related terminology correspondence information (2c); and accepts the classification sign C imparted from the manager to the document to which the classification sign “B” is not imparted in the imparting process.

The performance evaluation device according to one aspect of the present invention acquires digital information including document information and worker information, sets worker specifying information indicating which one of the workers included in the worker information has a relationship with the digital information, designates a worker, retrieves a document file in which the worker specifying information corresponding to the designated worker is set, highlights retrieved words, and performs an access right control capable of setting various authorities for each account of managers.

The performance evaluation device according to one aspect of the present invention acquires digital information including document information, worker information, and access history information, designates a specific worker from among the workers included in the worker information, extracts only the document information accessed by the specific worker based on the access history information about the designated specific worker, has a full-text retrieving function compatible with multiple languages, and outputs the document file related to a predetermined case from the extracted document information.

The performance evaluation device according to one aspect of the present invention extracts document groups from document information, accepts an input of classification signs from a reviewer to impart the classification signs indicating the relationship with a predetermined case to document groups, classifies the document groups for each classification sign, analyzes and selects a common keyword appearing in the classified document groups, searches for the selected keyword from the document information, calculates a score representing the relationship between a classification sign and a document by using the searched result and the result of analysis of the keyword, and imparts the classification sign to the document information based on the calculated score.

The performance evaluation device according to one aspect of the present invention acquires digital information including document information and worker information, sets worker specifying information indicating which one of the workers included in the worker information has a relationship with the digital information, designates a worker, retrieves document files in which the worker specifying information corresponding to the designated worker is set, collectively displays mail threads, accepts information indicating whether each of the extracted document files of the document information has a relationship with the predetermined case, and outputs the document file related to the predetermined case.

The performance evaluation device according to one aspect of the present invention acquires digital information including document information and worker information, accepts the designation of a document file included in the document information to be translated into any language, translates the document file, extracts common document files indicating the same content as the designated document file from the document information, sets additional information indicating whether each of the extracted document files of the document information has a relationship with the predetermined case, and outputs the document file related to the predetermined case based on the translation related information and the additional information.

The performance evaluation device according to one aspect of the present invention registers, in a database, a keyword for a reviewer to make a judgment as to a relationship with a predetermined case, retrieves the keyword registered in the database from the document information, extracts a sentence including the retrieved keyword from the document information, calculates a score indicating the degree of relevance to the predetermined case by a feature quantity extracted from the extracted sentence, and changes the degree of emphasis of the sentence according to the score.

The performance evaluation device according to one aspect of the present invention records, as performance information, a result of judgment by a reviewer as to the relevance to a predetermined case and a rate of progress of judgment as to the relevance, generates predicted information about the result or the rate of progress, compares the performance information with the predicted information, and generates an icon to present the evaluation by the reviewer on the judgment as to the relevance based on the comparison result.

The performance evaluation device according to one aspect of the present invention accepts an input from the reviewer as to result information indicating the relationship between each document group and a predetermined case, calculates, for each result information, the evaluation value of a common element from the feature of the element appearing in each document group, selects an element based on the evaluation value, calculates the score of the document data from the selected element and the evaluation value, and calculates a recall ratio based on the score.

The performance evaluation device according to one aspect of the present invention displays a document for a reviewer, accepts identification information (tag) which is imparted to an object document for review by the manager based on the judgment as to the relevance to a predetermined case, compares the feature quantity of the object document for which the tag is accepted with the feature quantity of the document, updates the score of the document corresponding to a predetermined tag based on the comparison result, and controls the order of display of documents to be displayed based on the updated score.

The performance evaluation device according to one aspect of the present invention records an updated source code when the source code is updated, creates an executable file from the recorded source code, executes the executable file to verify the file, transmits the executed verification result, and accepts, by a server, delivery of the verification result.

The performance evaluation device according to one aspect of the present invention displays document groups to be judged by a manager as to whether the data groups have a relationship with a predetermined case, and classification buttons for the manager to select a classification condition for classifying the document groups, accepts information about the classification button selected by the manager as selected information, classifies the document data according to the result obtained by analyzing the document groups based on the selected information, and displays the document group based on the classification result.

The performance evaluation device according to one aspect of the present invention confirms each piece of additional information of the document data, classifies the document data into threads based on the additional information, extracts, for each thread, an element included in the additional information of the classified document data, analyzes the degree of similarity between the threads based on the extracted element, and integrates the threads based on the degree of similarity.

The performance evaluation device according to one aspect of the present invention extracts a file with a password that is protected by the password, inputs a candidate word to the file with the password by using a dictionary file in which the candidate word, which is a candidate for the password, is registered, and accepts the result of the judgment by a manager as to the relationship with a predetermined case for the file, the password of which has been reset.

The performance evaluation device according to one aspect of the present invention divides data of a retrieved object file of a binary format into a plurality of blocks, retrieves the blocks of data from the retrieval destination file of the binary format, and outputs the retrieved result.

The performance evaluation device according to one aspect of the present invention selects object digital information as a research object, stores a combination of a plurality of words relevant to a specific matter, retrieves whether the selected object digital information includes the stored combination of words, judges, when the object digital information includes the combination of words, the relevance of the object digital information to the specific matter based on the result of the morphological analysis, and links the judgment result to the object digital information.

The performance evaluation device according to one aspect of the present invention extracts document groups from document information, accepts an input of classification signs from a user to impart the classification signs to the respective document groups, classifies the document groups for each classification sign, analyzes and selects a common keyword appearing the classified document groups, searches for the selected keyword from the document information, calculates a score using the searched result and the result of analysis of the keyword, imparts a classification sign to the document information based on the calculated score, displays, on a screen, the calculation result and classification result of the score, and calculates the number of documents necessary for reconfirmation based on the relationship between a recall ratio and a normalization rank.

The performance evaluation device according to one aspect of the present invention stores, in the keyword database, (1a) the classification sign “A”, (1b) a keyword included in the document to which the classification sign “A” is imparted, and (1c) keyword correspondence information indicating the correspondence relationship between the classification sign “A” and the keyword; stores, in the related terminology database, (2a) the classification sign “B”, (2b) the related terminology having a high appearance frequency in the document to which the classification sign “B” is imparted, and (2c) the related terminology correspondence information indicating the correspondence relationship between the classification sign “B” and the related terminology; imparts the classification sign “A” to the document including the above-mentioned keyword (1b) based on the above-mentioned keyword correspondence information (1c); extracts, in the imparting process, the document including the above-mentioned related terminology (2b) from the document to which the classification sign “A” is not imparted; calculates a score based on the evaluation value and the number of the related terminologies; imparts the classification sign “B” to a document having a score that exceeds a certain value based on the score and the above-mentioned related terminology correspondence information (2c); accepts, in the imparting process, the classification sign C imparted from the user to the document to which the classification sign “B” is not imparted; analyzes the document to which the classification sign C is imparted; and imparts a classification sign D to the document to which no classification sign is imparted, based on the analysis result.

The performance evaluation device according to one aspect of the present invention calculates, for each document, a score indicating a relationship with a predetermined case, extracts documents in a predetermined order based on the calculated score, accepts the classification sign which is imparted to the extracted document by the manager based on the relationship with the predetermined case, classifies the extracted documents for each classification sign based on the classification sign, analyzes and selects a common keyword included in the classified documents, searches for the selected keyword from the document information, and re-calculates a score for each document by using the searched result and analysis result.

The performance evaluation device according to one aspect of the present invention stores information related to a predetermined case in a research basic database, accepts an input of the category of the predetermined case, determines the research category to be searched based on the accepted category, and extracts the type of necessary information from the research basic database.

The performance evaluation device according to one aspect of the present invention stores a behavior generation model created based on a transmission/reception history of a message file on the network of the behavior subject that has performed a specific behavior, creates profile information of the subject based on the transmission/reception history of the message file on the network of the subject, calculates a score representing the adaptability between the profile information and the behavior generation model, and determines the possibility of occurrence of the specific behavior based on the score.

The performance evaluation device according to one aspect of the present invention collects, for a predetermined case, a case research result including a work performance classified for each case, registers an investigation model parameter for research for the predetermined case, retrieves the registered investigation model parameter upon receiving a research content for a new research case, extracts the investigation model parameter associated with the input information, outputs the research model using the extracted investigation model parameter, and configures prior information for carrying out the research for the new research case from the research model output result.

The performance evaluation device according to one aspect of the present invention acquires worker information about a worker, acquires digital information updated every predetermined period based on the worker information, organizes a plurality of files, which constitute the acquired digital information, at a predetermined storage location, based on the recording destination information, file name, and metadata about the acquired digital information, and creates a status distribution in which the status of each of the organized files is visualized so that the status of the user who has accessed to the digital information can be recognized.

The performance evaluation device according to one aspect of the present invention acquires metadata associated with digital information, updates a weighting parameter set based on the relationship between the metadata and first digital information having a relationship with a specific matter, and updates the relationship between the digital information and a morpheme by using the weighting parameter set.

The performance evaluation device according to one aspect of the present invention accepts the classification sign “A” which is manually imparted to object data, calculates a relevance score of the object data, determines true/false of the classification sign “A” based on the relevance score, and decides the classification sign to be imparted to the object data based on the result of judgment to be true or false.

The performance evaluation device according to one aspect of the present invention accepts an input of a category of a predetermined case, performs a research based on the accepted category, creates a report for reporting the researched result, stores information related to a predetermined case in a research basic database, determines a research category to be researched based on the accepted category, extracts the type of necessary information from the research basic database, presents the extracted type of information to the manager, accepts, from the manager, an input of a keyword or the like that is used to impart the classification sign and corresponds to the presented type of information, and automatically imparts the classification sign to a document.

The performance evaluation device according to one aspect of the present invention acquires published information of a subject, analyzes the published information, outputs an external element of the subject, stores a behavior generation model based on the behavior external element of the behavior subject that has performed a specific behavior, extracts and stores a behavior factor that matches the behavior generation model from the external element of the subject, acquires internal information of the subject, analyzes the inter al information, outputs an internal element of the subject, and automatically specifies the analyzed object based on the similarity between the internal element and the behavior factor.

The performance evaluation device according to one aspect of the present invention acquires, from a reviewer, relevance information indicating the relationship between digital information and a specific matter, calculates, for each digital information, the score of the relevance determined according to the association between the digital information and the specific matter, calculates, for each predetermined range of the relevance score, the ratio of the number of pieces of relevance information imparted to the digital information included in the range to the total of the digital information including the relevance score included in each range, and displays a plurality of sections linked to each range by changing the hue, lightness, or chroma based on the ratio.

The performance evaluation device according to one aspect of the present invention calculates, in chronological order, scores representing the strength of the relationship between a document and a classification sign, and detects a time-series change in the score from the calculated score. Further, when the detected time-series change in the score is determined, the performance evaluation device researches and determines the degree of relationship between the research case and the extracted document based on the result of the determination of the period in which the score is changed by an amount exceeding a predetermined criterion value.

The performance evaluation device according to one aspect of the present invention stores weighting information that has a relevance to a specific matter and is linked to a plurality of keywords including a co-occurrence expression, links a score to the digital information, extracts sample digital information as a sample from digital information based on the score, and analyzes the extracted sample digital information, thereby updating the weighting information.

The performance evaluation device according to one aspect of the present invention selects a category as an index capable of classifying each document included in a plurality of documents, and calculates a score for each category.

The performance evaluation device according to one aspect of the present invention specifies a predetermined action by a predetermined behavior subject, which causes a predetermined case, as a phase to be classified according to the progress of the predetermined action, based on a score, and estimates a change in the specified phase based on a temporal transition of the phase.

The performance evaluation device according to one aspect of the present invention stores a generation process model in which a predetermined action that causes a predetermined case is generated, for each of phases to be classified according to the progress of the predetermined action, stores information related to the predetermined case, for each category and generation process model, stores time-series information indicating a time sequence of the phase, analyzes the document information based on the above-mentioned three types of stored information, and calculates an index indicating the possibility that the predetermined action occurs, from the analysis result.

The performance evaluation device according to one aspect of the present invention stores the generation process model, in which a predetermined action that causes a predetermined case is generated, for each of phases to be classified according to the progress of the predetermined action, stores the information related to the predetermined case, for each category and generation process model, stores time-series information indicating a time sequence of phases, stores the relationship between a plurality of persons related to the predetermined case, analyzes the document information based on the above-mentioned four types of stored information, and specifies the current phase.

The performance evaluation device according to one aspect of the present invention specifies an object indicating the target of a verb when the verb indicating an operation is included in a document, associates the verb and object with metadata indicating the attribute of the document including the verb and the object, evaluates the relationship between the document and the case based on the association, and displays the relationship between a plurality of persons related to the case.

The performance evaluation device according to one aspect of the present invention acquires communication data, which is transmitted and received between a plurality of terminals and is linked to a plurality of persons, analyzes the content of the acquired communication data, evaluates the relationship between the content of the communication data and a predetermined case by using the analysis result, and displays the relationship between the plurality of persons related to the predetermined case based on the evaluation result.

The performance evaluation device according to one aspect of the present invention calculates the score representing the strength of the relationship between the document included in the document information and the classification sign indicating the degree of relevance of the predetermined case, reports the score to the user according to the calculated score, and outputs the research report depending on the research type of the predetermined case.

The performance evaluation device according to one aspect of the present invention refers to the database storing the classified information associated with the degree of secrecy, calculates the degree of leakage indicating the risk of leakage of the classified information due to an access to the outside of the network, and determines whether the degree of secrecy or the degree of leakage satisfies the criterion of the leakage of the classified information. Further, when it is determined that the degree of secrecy or the degree of leakage satisfies the criterion, the performance evaluation device specifies the subject of leakage.

The performance evaluation device according to one aspect of the present invention compares a group A of behaviors included in a certain period with a group B of behaviors included in the latest period, extracts the difference between the group A and the group B, and determines whether the extracted difference has reached the criterion which suggests an increase in the risk of leakage of the classified information. Further, when it is determined that the difference has reached the criterion, the performance evaluation device reports the risk to the manager.

The performance evaluation device according to one aspect of the present invention generates, for each sentence, a keyword vector indicating whether a predetermined keyword is included in each sentence included in a document, obtains correlation vectors for each sentence by multiplying the keyword vector by a correlation matrix indicating the correlation between the predetermined keyword and another keyword, and calculates a score based on the value obtained by adding up all the correlation vectors.

The performance evaluation device according to one aspect of the present invention specifies, from a score calculated for judged data (data judged by a manager and with a tag), a threshold for classifying unjudged data (data unjudged by the manager and with no tag), and sets the unjudged data as data to be reported to the manager according to the result of a comparison between the specified threshold and the score calculated for the unjudged data.

The performance evaluation device according to one aspect of the present invention learns weighting of a keyword included in a classified document that is classified by a manager as to whether the classified document has a relationship with a predetermined case, searches for the keyword included in the classified document from a non-classified document, which is not classified by the manager as to whether the document has a relationship with the predetermined case, and calculates a score obtained by evaluating the strength of the relationship between the non-classified document and a classification sign by using the searched keyword and the learned weighting of the keyword.

### REFERENCE SIGNS LIST

1: Data, 1a: Data, 1b: Data, 5a: Review result (result of judgment by a manager), 5d: Score, 5e: Score, 6: Threshold (predetermined threshold) of the precision ratio, 11: Data acquisition unit, 12: Judged data acquisition unit, 13: Element evaluation unit, 14: Score calculation unit, 15: Condition determination unit, 16: Relationship evaluation unit, 17: Relation imparting unit, 18: Data report unit, 19: Threshold specifying unit, 100: Performance evaluation device

1. A performance evaluation device that evaluates a performance of a worker based on data, the performance evaluation device comprising:
a storage unit storing judged data as basic information for evaluating a quality of the performance by a manager;
a relationship evaluation unit configured to evaluate, when unjudged data is newly acquired from the worker, a relationship between the unjudged data and excellence of the performance based on the judged data stored in the storage unit, the unjudged data not used as the basic information for evaluating the quality of the performance; and
a quality determination unit configured to determine the quality of the performance according to the relationship evaluated by the relationship evaluation unit.

2. The performance evaluation device according to claim 1, further comprising a score calculation unit configured to calculate a score representing a strength of a relationship between predetermined data and the excellence of the performance, wherein
the relationship evaluation unit evaluates whether or not there is a relationship between the unjudged data and the excellence of the performance by using the score calculated by the score calculation unit as an index indicating the relationship between the unjudged data and the excellence of the performance, and
wherein the quality determination unit determines that the performance is excellent when the relationship evaluation unit evaluates that there is a relationship between the unjudged data and the excellence of the performance.

3. The performance evaluation device according to claim 2, further comprising an element evaluation unit configured to evaluate each of a plurality of data elements included in the judged data based on a predetermined criterion, wherein
the score calculation unit calculates the score by using a result of the evaluation by the element evaluation unit.

4. The performance evaluation device according to claim 3, further comprising a threshold specifying unit configured to specify, as an index indicating the relationship between the judged data and the excellence of the performance by using a result of the evaluation by the element evaluation unit, a score among scores calculated by the score calculation unit which can exceed a target value set for a precision ratio, as a predetermined threshold.

5. The performance evaluation device according to any one of claims 2 to 4, further comprising a condition determination unit configured to determine a rank of a correlation between: a moving average of scores calculated for a plurality of pieces of judged data acquired in time series, and a moving average of scores calculated for a plurality or pieces of unjudged data acquired in time series,
Wherein the relationship evaluation unit evaluates the relationship between the unjudged data and the excellence of the performance based on a result of the determination by the condition determination unit.

6. The performance evaluation device according to any one of claims 1 to 5, further comprising a judged data acquisition unit configured to acquire the judged data by acquiring a result of determination by the manager as to whether the predetermined data has a relationship with the excellence of the performance via a predetermined input unit from the manager.

7. The performance evaluation device according to any one of claims 1 to 6, further comprising a relation imparting unit configured to impart relationship information indicating that the unjudged data has a relationship with the excellence of the performance, based on a result of evaluation by the relationship evaluation unit.

8. The performance evaluation device according to any one of claims 1 to 7, further comprising a data acquisition unit configured to acquire at least one of a report, an e-mail, and a presentation material as the data.

9. A control method for a performance evaluation device that evaluates a performance of a worker based on data, the control method comprising:
a relationship evaluation step of evaluating, when unjudged data is newly acquired from the worker, a relationship between the unjudged data and excellence of the performance based on judged data used as basic information for evaluating a quality of the performance by a manager, the unjudged data not used as the basic information for evaluating the quality of the performance; and
a quality determination step of determining the quality of the performance according to the relationship evaluated in the relationship evaluation step.

10. A control program for a performance evaluation device that evaluates a performance of a worker based on data, the performance evaluation device including a storage unit configured to store judged data used as basic information for evaluating a quality of the performance by a manager, the control program causing the performance evaluation device to execute:
a relationship evaluation function of evaluating, when unjudged data is newly acquired from the worker, a relationship between the unjudged data and excellence of the performance based on the judged data stored in the storage unit, the unjudged data not used as the basic information for evaluating the quality of the performance; and
a quality determination function of determining the quality of the performance according to the relationship evaluated by the relationship evaluation function.
